(19) United States
(12) Patent Application Publication
(10) Pub. No.: US 2025/0110520 A1
(43) Pub. Date: Apr. 3, 2025

(54) SOLAR POWER GENERATION SYSTEM AND MONITORING METHOD THEREOF

(71) Applicant: Quanta Computer Inc., Taoyuan City (TW)

(72) Inventors: Hung-Sheng HSUEH, Taoyuan City (TW); Yi-Chun HSIAO, Taoyuan City (TW); Sheng-Chih LU, Taoyuan City (TW)

(21) Appl. No.: 18/539,446

(22) Filed: Dec. 14, 2023

(30) Foreign Application Priority Data
Sep. 28, 2023 (TW) 112137375

(51) Int. Cl. G05F 1/67; H02J 3/38; H02J 7/35

(52) U.S. Cl. CPC G05F 1/67; H02J 7/35; H02J 3/381; H02J 2300/26

(57) ABSTRACT

A monitoring method for a solar power generation system is provided. The solar power generation system includes a solar panel and a maximum power point tracking (MPPT) device. The monitoring method includes receiving a current output power of the solar power generation system from the MPPT device; and sensing a current value of an environment parameter through a sensor. The monitoring method further includes comparing an ideal output power corresponding to the current value of the environment parameter and the current output power according to a conversion table; and in response to a ratio of current output power to ideal output power being less than a first percentage, issuing a first warning.

### CROSS REFERENCE TO RELATED APPLICATIONS

This application claims priority of Taiwan Patent Application No. 112137375, filed on Sep. 28, 2023, the entirety of which is incorporated by reference herein.

### BACKGROUND OF THE INVENTION

### Field of the Invention

The present disclosure relates to a monitoring method for a solar power generation system, and, in particular, to a monitoring method for monitoring the level of contamination on the surface of solar panel.

### Description of the Related Art

Since the stock of fossil fuels is limited and the negative impact of fossil fuels on the environment needs to be mitigated, the development of renewable energy has long been a very important issue. Among various renewable energy sources, solar power generation has always occupied a pivotal position. In order to increase the efficiency of solar power generation, the output voltage and/or output current of the solar power generation system can be adjusted, so that the solar power generation system can obtain maximum output power.

However, the output power of a solar power generation system will be affected by the contamination level on the surface of the solar panel. For example, when the surface of the solar panel is covered with contamination to a certain extent, it will have a significant impact on the output power of the solar power generation system. Therefore, a system and method are needed to monitor the contamination level on the surface of the solar panels in the solar power generation system.

### BRIEF SUMMARY OF THE INVENTION

An embodiment of the present invention provides a solar power generation system. The solar power generation system comprises a solar panel, a maximum power point tracking (MPPT) device connected to the solar panel, and an agriculture field monitoring system connected to the MPPT device. The MPPT device is configured to control an output voltage of the solar power generation system so that the solar power generation system outputs a current output power. The agriculture field monitoring system comprises a processing device, a sensor configured to sense an environment parameter, and a storage device configured to store a program. The program comprises a conversion table recording the environment parameter and an ideal output power. When the program is loaded and executed by the processing device, the agriculture field monitoring system performs following operations: obtaining a current value of the environment parameter through the sensor; comparing the ideal output power corresponding to the current value of the environment parameter and the current output power based on the conversion table; and in response to a ratio of the current output power to the ideal output power being less than a first percentage, issuing a first warning.

An embodiment of the present invention provides a monitoring method for a solar power generation system. The solar power generation system comprises a solar panel and a maximum power point tracking (MPPT) device. The monitoring method comprises receiving a current output power of the solar power generation system from the MPPT device; and sensing a current value of an environment parameter through a sensor. The monitoring method further comprises comparing an ideal output power corresponding to the current value of the environment parameter and the current output power using a conversion table; and in response to a ratio of the current output power to the ideal output power being less than a first percentage, issuing a first warning.

### BRIEF DESCRIPTION OF THE DRAWINGS

The present disclosure is best understood from the following detailed description when read with the accompanying figures. It is emphasized that, in accordance with the standard practice in the industry, various features are not drawn to scale and are used for illustration purposes only. In fact, the dimensions of the various features may be arbitrarily increased or reduced for clarity of discussion.

FIG. 1 illustrates a diagram of current-voltage curve and power-voltage curve of a solar power generation system, in accordance with some embodiments of the present disclosure.

FIG. 2 illustrates a block diagram of the solar power generation system, in accordance with some embodiments of the present disclosure.

FIG. 3 illustrates a schematic diagram of the relationship between the output power of the solar power generation system and the ultraviolet index, in accordance with some embodiments of the present disclosure.

FIG. 4 illustrates a flowchart of a method for monitoring the solar power generation system, in accordance with some embodiments of the present disclosure.

### DETAILED DESCRIPTION OF THE INVENTION

The following disclosure provides many different embodiments, or examples, for implementing different features of the provided subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Still further, unless specifically disclaimed, the singular includes the plural and vice versa. And when a number or a range of numbers is described with “about,” “approximate,” and the like, the term is intended to encompass numbers that are within a reasonable range including the number described, such as within +/−10% of the number described or other values as understood by person skilled in the art. In addition, the present disclosure is not limited by the illustrated ordering of acts or events, as some acts may occur in different orders and/or concurrently with other acts or events. Furthermore, not all illustrated acts or events are required to implement a methodology in accordance with the present disclosure.

In general, the output power of solar panels will change due to different solar irradiance, and the solar irradiance will change with factors such as season, time, angle, and external environment. Therefore, a maximum power point tracking (MPPT) module is usually added to a solar power generation system to stabilize the output power of the solar power generation system. At the same time, the MPPT module will also adjust the output voltage and/or output current of the solar power generation system according to the voltage and current characteristics generated by the solar panel, so as to maximize the output power of the solar power generation system as much as possible. In other words, the MPPT module looks for a current maximum power point. At the maximum power point, the solar power generation system has maximum output power. The maximum output power (Pmpp) is the product of the corresponding maximum output point voltage (Vmpp) and the corresponding maximum output point current (Impp).

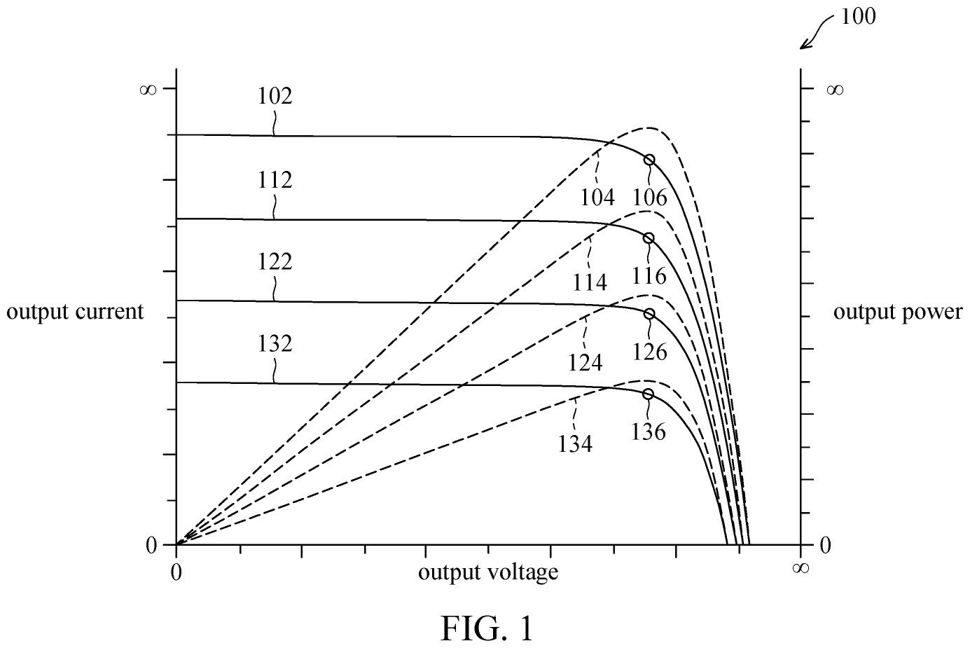

FIG. 1 illustrates a diagram 100 of current-voltage curve and power-voltage curve of a solar power generation system. The diagram 100 illustrates the relationship between the output current and the output voltage and the relationship between the output power and the output voltage under different solar irradiance. Under a first solar irradiance, the relationship between the output current and the output voltage is represented as a curve 102, the relationship between the output power and the output voltage is represented as a curve 104, and the maximum power point is represented as a point 106. Under a second solar irradiance that is less than the first solar irradiance, the relationship between the output current and the output voltage is represented as a curve 112, the relationship between the output power and the output voltage is represented as a curve 114, and the maximum power point is represented as a point 116. Under a third solar irradiance that is less than the second solar irradiance, the relationship between the output current and the output voltage is represented as a curve 122, the relationship between the output power and the output voltage is represented as a curve 124, and the maximum power point is represented as a point 126. Under a fourth solar irradiance that is less than the third solar irradiance, the relationship between the output current and the output voltage is represented as a curve 132, the relationship between the output power and the output voltage is represented as a curve 134, and the maximum power point is represented as a point 136.

As shown in FIG. 1, the stronger the solar irradiance, the greater the maximum power point of the solar power generation system (i.e., the power at the point 106 is greater than the power at the point 116, the power at the point 116 is greater than the power at the point 126, and the power at the point 126 is greater than the power at the point 136). Moreover, the maximum power point when the output power is maximum is not located at the maximum output voltage (i.e., open circuit voltage) or the maximum output current (i.e., short circuit current). In addition, the ultraviolet (UV) index has the same trend as the solar irradiance. That is, the higher the UV index, the greater the maximum power point of the solar power generation system.

As shown in FIG. 1, when the output voltage and output current leave the maximum power point, the output power of the solar power generation system will decrease accordingly, even decrease to lower than the output power that is under weaker solar irradiance. Taking the curve 104 of the first solar irradiance as an example, when the output voltage moves left (i.e., decreases) or right (i.e., increases) from the voltage corresponding to the point 106, the output power will also decrease. As shown by the curve 104, the output power of the first solar irradiance may even drop below the maximum power point of the second solar irradiance (i.e., point 116). Therefore, the solar power generation system requires MPPT modules to look for the maximum power point to maximize the output power as much as possible.

However, in addition to solar irradiance or UV index, the contamination level of the solar panels of the solar power generation system will also affect the power generation efficiency of the solar power generation system. The contamination on the surface of the solar panel (e.g., dust, dirt, fallen leaves, bird droppings, water stains, etc.) will reduce the smoothness and transparency of the solar panel surface, and thus reduce the light absorptivity rate of the solar panel. As a result, under the same solar irradiance or UV index, the power generation efficiency of the solar power generation system will be lower than the ideal power generation efficiency without contamination.

In modern agriculture, the agriculture field monitoring systems are often installed in fields to assist tillage. In general, the agriculture field monitoring system includes a variety of sensors to sense various parameters related to agriculture, such as temperature, humidity, solar irradiance, UV index, wind speed, wind direction, rainfall, etc. The sensors for sensing solar irradiance and UV index are among these sensors. Since the agriculture field monitoring systems are installed in fields, they are often adjacent to places where solar power generation systems are installed. Therefore, the solar power generation system may be combined with adjacent agriculture field monitoring system, so as to utilize the sensors on the agriculture field monitoring system to determine whether the power generation efficiency of the solar power generation system is consistent with current weather conditions.

Therefore, the present disclosure provides a solar power generation system combined with agriculture field monitoring system and a monitoring method thereof. The monitoring method can compare the current output power of the solar power generation system with the ideal output power under current sunlight conditions. When the current output power is less than the ideal output power, the monitoring method can determine the contamination level of the solar panel of the solar power generation system based on the difference between the current output power and the ideal output power, and issue different warnings corresponding to the different contamination level. In this way, the contamination level of the solar panel can be monitored at any time and the user can be notified immediately to clean the solar panel.

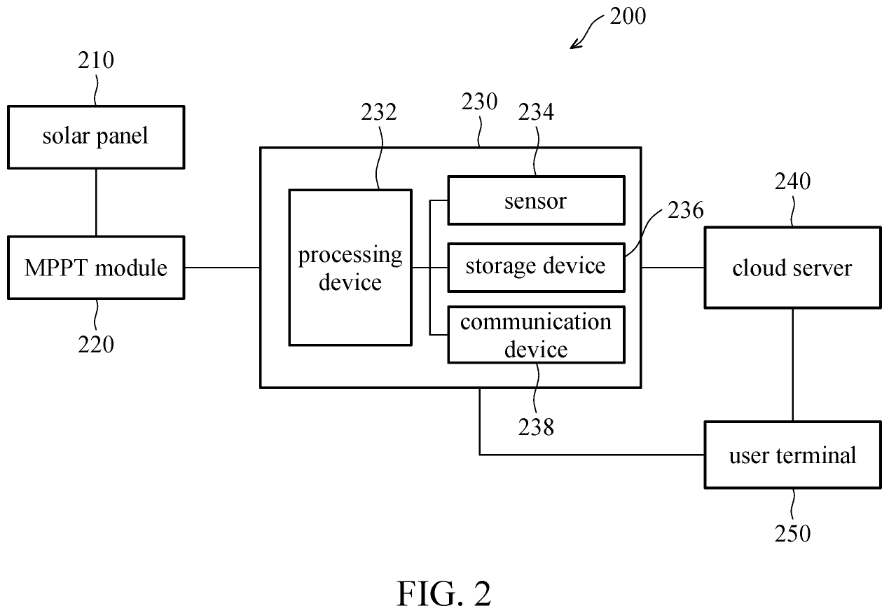

FIG. 2 illustrates a block diagram of a solar power generation system 200, in accordance with some embodiments of the present disclosure. The solar power generation system 200 includes a solar panel 210, a maximum power point tracking (MPPT) module 220, and an agriculture field monitoring system 230. In some embodiments, the solar panel 210 may be a solar panel array composed of a plurality of solar panels. In other embodiments, the solar panel 210 may include a plurality of solar panel arrays.

The MPPT module 220 may be connected to the solar panel 210, and receive the voltage and current generated by the solar panel 210. In some embodiments, the MPPT module 220 is configured to look for the maximum power point according to the voltage and current generated by the solar panel 210. Then, the MPPT module 220 controls the output voltage and/or output current of the solar power generation system 200 at the maximum output point voltage and/or the maximum output point current corresponding to the maximum power point, so that the solar power generation system 200 can generate maximum output power. In some embodiments, the MPPT module 220 includes a power converter. The power converter is configured to receive the voltage and current generated by the solar panel 210 and convert them into output voltage and output current. For example, the power converter may be a DC-DC converter or an AC-DC rectifier paired with the DC-DC converter.

In some embodiments, the MPPT module 220 includes a voltage detector configured to detect the output voltage and output current of the power converter. In some embodiments, the MPPT module 220 includes a controller, the controller is configured to receive the output voltage and output current detected by the voltage detector and calculate the maximum power point. Then, the controller outputs a control signal to the power converter based on the calculated maximum power point, so as to make the power converter output the maximum output point voltage and maximum output point current corresponding to the maximum power point. As a result, the MPPT module 220 can output the maximum output power corresponding to the maximum power point. For example, the controller may be or include a microprocessor.

In some embodiments, the solar power generation system 200 further includes a load (not shown). The load is connected to the MPPT module 220 and is driven by the output voltage and output current of the power converter of the MPPT module 220. For example, the load may be an electronic device or an energy storage device used to store electrical energy. In some embodiments, the load may include agriculture field monitoring system 230.

In some embodiments, the agriculture field monitoring system 230 includes a processing device 232, and a sensor 234, a storage device 236 and a communication device 238 coupled to the processing device 232. The agriculture field monitoring system 230 is connected to the MPPT module 220, and can receive the charging status of the solar power generation system 200 (e.g., the output voltage, output current, and output power output by the MPPT module 220) from the MPPT module 220. In some embodiments, the processing device 232 may be an integrated circuit (IC) device, such as a processor, a microprocessor, a controller, a system on chip (SoC), other suitable integrated circuits, or combinations thereof.

The sensor 234 may be configured to sense environmental parameters. In some embodiments, the sensor 234 is an infrared (IR) sensor or an ultraviolet (UV) sensor configured to sense the current solar irradiance (unit: watts per square meter (W/m²)) or UV index. In some embodiments, the storage device 236 may store an application program including a method 400 described below and a conversion table. The conversion table records environmental parameters and ideal output power used in the application program. The ideal output power corresponding to a value of the environmental parameters can be found in the conversion table according to the value. In other words, the conversion table includes a large number of values of environmental parameters and the ideal output power corresponding to these values. The ideal output power refers to the maximum output power that the solar power generation system 200 can output through the MPPT module 220 under the ideal situation that there is no contamination (or only extremely limited contamination) on the surface of the solar panel 210 of the solar power generation system 200.

In some embodiments, the conversion table shows the relationship between the first environmental parameter (e.g., UV index) and/or the second environmental parameter (e.g., solar irradiance) and the ideal output power. For example, the conversion table shows the ideal output power corresponding to different UV indices, and/or the ideal output power corresponding to different solar irradiance.

In some embodiments, the conversion table may be established in advance through the solar panel 210, the MPPT module 220, and the agriculture field monitoring system 230. For example, the agriculture field monitoring system 230 can collect and record the output power of the MPPT module 220, and at the same time collect and record the environmental parameters (e.g., UV index and/or solar irradiance) sensed by the sensor 234, when it is ensured that the surface of the solar panel 210 is clean (e.g., the solar panel 210 has just been cleaned or is monitored by staff in real time). In this way, ideal output power corresponding to different values of environmental parameter (e.g., different UV indices and/or different solar irradiance) can be obtained.

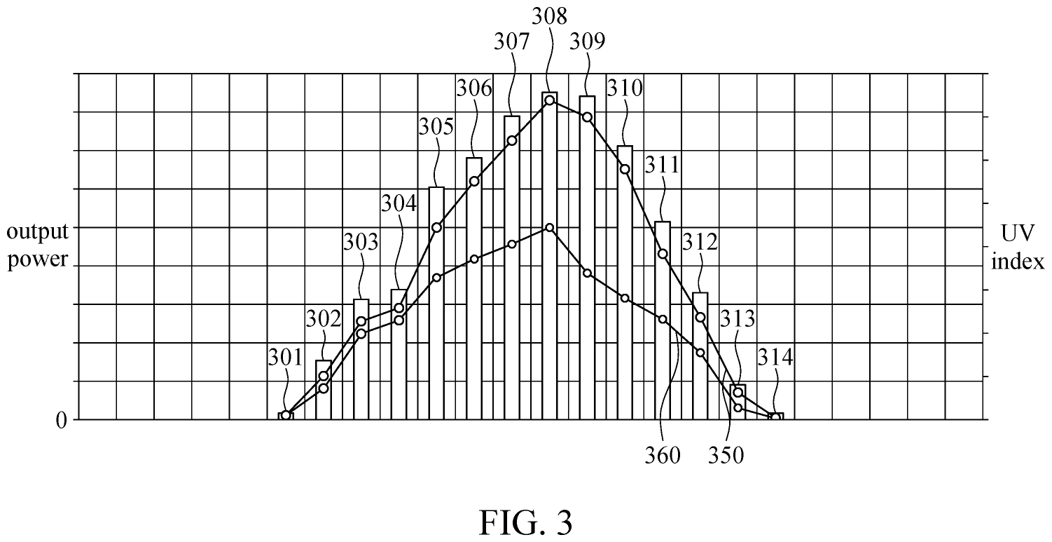

Referring to FIG. 3, FIG. 3 illustrates a schematic diagram of the relationship between the output power of the solar power generation system 200 and the UV index. In the schematic diagram of FIG. 3, the left vertical axis represents the output power, and the right vertical axis represents the UV index. In the schematic diagram of FIG. 3, strips 301˜314 represent the UV index, and curve 350 represents the ideal output power corresponding to different UV indices. As shown in FIG. 3, as the UV index (i.e., strips 301˜314) increases, the ideal output power (i.e., curve 350) also increases. Therefore, the corresponding ideal output power can be obtained according to the sensed UV index. In addition, solar irradiance has the same trend as UV index. In other words, the corresponding ideal output power can also be obtained according to the sensed solar irradiance.

Still referring to FIG. 3, curve 360 represents the actual output power that the solar power generation system 200 can output through the MPPT module 220 under different UV indices when the surface of the solar panel 210 has contamination. As shown in FIG. 3, as the UV index (e.g., strips 301˜314) increases, the actual output power (e.g., curve 360) also increases. However, due to the presence of contamination on the surface of the solar panel 210, the actual output power (i.e., curve 360) is less than the ideal output power (i.e., curve 350), as shown in FIG. 3. Since the actual output power is less than the ideal output power, the power generation efficiency of the solar power generation system 200 is reduced. Therefore, the present disclosure proposes a monitoring method (i.e., the method 400 described below), the monitoring method determines the contamination level of the solar panel 210 based on the difference between the actual output power and the ideal output power of the solar power generation system 200, and transmits relevant information to the user.

It should be noted that, FIG. 3 is only an example. In some embodiments, the conversion table may not have the strips and curves shown in FIG. 3, but simply exists in the form of a sheet. In some embodiments, the conversion table may include time parameters to make the ideal output power obtained through the environmental parameter more accurate. For example, the time parameters may include season, month, week, date, sunrise time, etc. In these embodiments, conversion tables corresponding to different seasons, months, weeks, dates and/or sunrise times can be established, such that these conversion tables can be used for different seasons, months, weeks, dates and/or sunrise times. For example, if a value of solar irradiance is measured in winter, it can search for the ideal output power corresponding to this value in a winter conversion table.

In some embodiments, the conversion table may include sun position parameters to make the ideal output power obtained through the environmental parameter more accurate. For example, the sun position parameters may include solar altitude, solar azimuth, and the like. In these embodiments, conversion tables corresponding to different solar altitudes and/or solar azimuths can be established, such that these conversion tables can be used for different solar altitudes and/or solar azimuths. For example, if a value of solar irradiance is measured at a specific solar altitude, it can search for the ideal output power corresponding to this value in a conversion table corresponding to the specific solar altitude.

Referring to FIG. 2 again, in some embodiments, the solar power generation system 200 may be further connected to a cloud server 240 and/or a user terminal 250. The agriculture field monitoring system 230 may be connected to the MPPT module 220, the cloud server 240 and/or the user terminal 250 in a wired and/or wireless manner through the communication device 238. For example, the agriculture field monitoring system 230 may receive the charging status of the solar power generation system 200 from the MPPT module 220 through the communication device 238. For example, the agriculture field monitoring system 230 can transmit information to the cloud server 240 through the communication device 238, and transmit the information directly and/or through the cloud server 240 to the user terminal 250.

In some embodiments, the cloud server 240 can connect and manage multiple solar power generation systems 200 at the same time. In some embodiments, the processing device 232 and the storage device 236 of the agriculture field monitoring system 230 may be disposed in the cloud server 240, and functions related to the processing device 232 and the storage device 236 are performed by the cloud server 240. In some embodiments, the solar power generation system 200 may include an additional device that integrate the processing device 232, the sensor 234, the storage device 236, and the communication device 238, so that the agriculture field monitoring system 230 can be omitted. In some embodiments, the user terminal 250 may be a terminal held by a user or manager of the solar power generation system 200. For example, the user terminal 250 can be a personal computer, a tablet computer, a mobile phone, and the like. In some embodiments, the user terminal 250 may directly communicate with the agriculture field monitoring system 230. Alternatively, the user terminal 250 may communicate with the agriculture field monitoring system 230 through the cloud server 240.

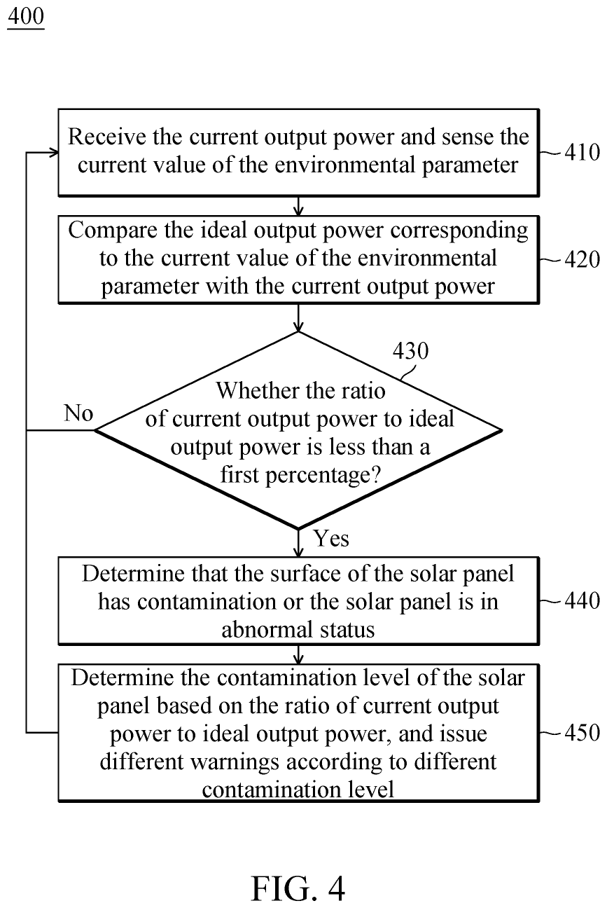

FIG. 4 illustrates a flowchart of the method 400 for monitoring the solar power generation system, in accordance with some embodiments of the present disclosure. It is noted that, additional operations may be provided before, during or after the method 400, and some operations described can be moved, replaced, or eliminated for additional embodiments of the method 400. In some embodiments, method 400 may be performed by processing device 232. For example, method 400 may be implemented as an application program and stored in the storage device 236, and loaded and executed by the processing device 232. The following description will be made with reference to FIG. 2 and FIG. 4 simultaneously.

The method 400 begins with operation 410. In operation 410, the method 400 receives the current output power of the solar power generation system and simultaneously senses the current value of the environmental parameter. For example, through the agriculture field monitoring system 230, the current charging status of the solar power generation system 200 can be received from the MPPT module 220 and the environmental parameter can be obtained by the sensor 234 at the same time. In some embodiments, the processing device 232 of the agriculture field monitoring system 230 can receive a current output power that is actually output from the MPPT module 220, and obtain the current value of the environmental parameter (e.g., current UV index and/or solar irradiance) at the same time point through the sensor 234.

Next, the method 400 proceeds to operation 420. In operation 420, the method 400 compares the ideal output power corresponding to the current value of the environmental parameter with the current output power. For example, the ideal output power can be compared with the current output power by the processing device 232 of the agriculture field monitoring system 230. In some embodiments, the processing device 232 can find the ideal output power corresponding to the current value of the environmental parameter according to the conversion table stored in the storage device 236. Then, the processing device 232 may compare the ideal output power corresponding to the current value of the environmental parameter with the current output power received from the MPPT module 220, and calculate the ratio of current output power to ideal output power.

Next, the method 400 proceeds to operation 430. In operation 430, the method 400 determines whether the ratio of current output power to ideal output power is less than a first percentage. For example, the processing device 232 of the agriculture field monitoring system 230 can be used to determine whether the ratio of current output power to ideal output power is less than the preset first percentage. In some embodiments, when the ratio of current output power to ideal output power is greater than the first percentage, the processing device 232 determines that the solar panel 210 has sufficient power generation efficiency. It means that the surface of the solar panel 210 has no contamination or the contamination level can be negligible. At this time, the method 400 returns to operation 410 and is continuously performed, so as to continuously monitor the solar power generation system 200.

In some embodiments, when the ratio of current output power to ideal output power is less than the first percentage, the method 400 proceeds to operation 440. In operation 440, the processing device 232 determines that the output power of the solar panel 210 is insufficient, which means that the surface of the solar panel 210 has contamination.

Next, after operation 440, the method 400 proceeds to operation 450. In operation 450, the method 400 determines the contamination level of the solar panel based on the ratio of current output power to ideal output power, and issues different warnings according to the contamination level. For example, the processing device 232 of the agriculture field monitoring system 230 may determine the contamination level of the surface of the solar panel 210 based on different ratios between the current output power and the ideal output power, and make different responses. In some embodiments, in response to the ratio of current output power to ideal output power being less than the first percentage but greater than a second percentage, the processing device 232 determines that the contamination level of the surface of the solar panel 210 is mild level, and issues a first warning. In some embodiments, in response to the ratio of current output power to ideal output power being less than the second percentage but greater than a third percentage, the processing device 232 determines that the contamination level of the surface of the solar panel 210 is intermediate level, and issues a second warning. In some embodiments, in response to the ratio of current output power to ideal output power being less than the third percentage, the processing device 232 determines that the contamination level of the surface of the solar panel 210 is severe level, and issues a third warning.

In some embodiments, the first percentage is 90% (i.e., the current output power is less than the ideal output power by 10%), the second percentage is 70% (i.e., the current output power is less than the ideal output power by 30%), and the third percentage is 50% (i.e., the current output power is less than the ideal output power by 50%). In other embodiments, the first percentage is 95%, the second percentage is 80%, and the third percentage is 65%. It should be noted that, the first warning, second warning and third warning as well as the first percentage, second percentage and third percentage are merely examples, and the present disclosure is not limited thereto. For example, the number of warning, the severity level, and the percentage value used to classify the severity level can be set depend on needs.

In some embodiments, the contents of the first warning, the second warning and the third warning all include the ratio of current output power to ideal output power. In some embodiments, because the relationship between the contamination level is that the third warning is greater than the second warning and the second warning is greater than the first warning, the third warning has content that is more intense than the second warning and the second warning has content that is more intense than the first warning. For example, the third warning may be accompanied by a louder sound effect than the second warning, and the second warning may be accompanied by a louder sound effect than the first warning. Alternatively, the third alert, the second alert, and the first alert may use different text or different background colors.

In some embodiments, in operation 450, the method 400 further includes transmitting the content of warning to the cloud server and/or the user terminal to notify the user or staff to clean or maintain the solar power generation system. For example, the content of warning can be transmitted to the cloud server 240 and/or the user terminal 250 through the communication device 238 of the agriculture field monitoring system 230. In some embodiments, the communication device 238 may directly transmit the first warning, the second warning, and the third warning to the cloud server 240 and the user terminal 250. In other embodiments, the communication device 238 transmits the first warning, the second warning, and the third warning to the user terminal 250 through the cloud server 240. In some embodiments, the contents of the first warning, the second warning, and the third warning include the contamination level and the ratio of current output power to ideal output power, so as to remind the user or staff to clean or maintain the solar power generation system.

After operation 450, the method 400 may return to operation 410 and be continuously performed, so as to continuously monitor the solar power generation system 200. In some embodiments, method 400 is performed by a fixed period. For example, the period may be 5 minutes, 10 minutes, 30 minutes, 1 hour, etc., but the present disclosure is not limited thereto. Furthermore, in addition to the contamination on the surface of the solar panel, the actual output power of the solar power generation system may be lower than the ideal output power due to other abnormal conditions. Therefore, the method 400 and the first warning, the second warning, and the third warning described above also have the function of reminding the user or manager that an abnormality occurs in the solar power generation system. This can make the user or manager inspect and maintain the solar power generation system. It should be noted that, both the current output power and ideal output power described herein are the powers output after optimizing through the maximum power point tracking technology.

The present disclosure provides a solar power generation system and a monitoring method thereof. The monitoring method can compare the current output power of a solar power system with the ideal output power under current sunlight conditions. The monitoring method can determine the contamination level of the solar panels of the solar power generation system according to the difference between the current output power and the ideal output power, and issue different warnings corresponding to different contamination level. As a result, the contamination level of the solar panel can be monitored at any time and the user can be notified immediately to clean the solar panel.

The foregoing has outlined features of several embodiments so that those skilled in the art may better understand the detailed description that follows. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A solar power generation system, comprising:
a solar panel;
a maximum power point tracking (MPPT) device, connected to the solar panel, wherein the MPPT device is configured to control an output voltage of the solar power generation system so that the solar power generation system outputs a current output power;
an agriculture field monitoring system, connected to the MPPT device, wherein the agriculture field monitoring system comprises:
a processing device;
a sensor, configured to sense an environment parameter; and
a storage device, configured to store a program, wherein the program comprises a conversion table recording the environment parameter and an ideal output power, when the program is loaded and executed by the processing device, the agriculture field monitoring system performs following operations:
obtaining a current value of the environment parameter through the sensor;
comparing the ideal output power corresponding to the current value of the environment parameter and the current output power based on the conversion table; and
in response to a ratio of the current output power to the ideal output power being less than a first percentage, issuing a first warning.

2. The solar power generation system as claimed in claim 1, wherein the agriculture field monitoring system further performs:
in response to the ratio of the current output power to the ideal output power being less than a second percentage, issuing a second warning, wherein the second percentage is less than the first percentage.

3. The solar power generation system as claimed in claim 1, wherein the environment parameter is an ultraviolet (UV) index.

4. The solar power generation system as claimed in claim 1, wherein the environment parameter is solar irradiance.

5. The solar power generation system as claimed in claim 1, wherein the first warning is transmitted to a cloud server, and transmitted to a user terminal through the cloud server.

6. A monitoring method for a solar power generation system, wherein the solar power generation system comprises a solar panel and a maximum power point tracking (MPPT) device, the monitoring method comprising:
receiving a current output power of the solar power generation system from the MPPT device;
sensing a current value of an environment parameter through a sensor;
comparing an ideal output power corresponding to the current value of the environment parameter and the current output power according to a conversion table; and
in response to a ratio of the current output power to the ideal output power being less than a first percentage, issuing a first warning.

7. The monitoring method as claimed in claim 6, further comprising:
in response to the ratio of the current output power to the ideal output power being less than a second percentage, issuing a second warning, wherein the second percentage is less than the first percentage.

8. The monitoring method as claimed in claim 6, further comprising:
transmitting the first warning to a cloud server; and
transmitting the first warning to a user terminal through the cloud server.

9. The monitoring method as claimed in claim 6, wherein the sensor is an ultraviolet sensor.

10. The monitoring method as claimed in claim 6, wherein the conversion table comprises values of the environment parameter and values of the ideal output power corresponding to the values of the environment parameter.
